(19) United States
(12) Patent Application Publication
(10) Pub. No.: US 2026/0341086 A1
(43) Pub. Date: Oct. 29, 2026

(54) ELECTRONIC KEY MANAGEMENT DEVICE, ELECTRONIC KEY MANAGEMENT SYSTEM, ELECTRONIC KEY MANAGEMENT METHOD, AND MANAGEMENT METHOD OF ELECTRONIC KEY MANAGEMENT SYSTEM

(71) Applicant: Sharp Kabushiki Kaisha, Sakai City (JP)

(72) Inventor: Michitaka NAITOU, Sakai City (JP)

(21) Appl. No.: 19/699,596

(22) Filed: Jun. 5, 2026

Related U.S. Application Data
(63) Continuation of application No. PCT/JP2023/046067, filed on Dec. 22, 2023.

(51) Int. Cl. G07C 9/00

(52) U.S. Cl. CPC G07C 9/00571; G07C 9/00309; G07C 9/00904; G07C 2009/00341; G07C 2009/00769; G07C 2209/02

(57) ABSTRACT

An electronic key management device manages an electronic key to unlock a key installed in a facility. An electronic device fixedly provided in the facility acquires first identification information individually allocated to a first terminal device and second identification information individually allocated to a second terminal device different from the first terminal device from the first terminal device used by a user arriving at the facility. The first identification information, the second identification information, and third identification information individually allocated to the electronic device are transmitted from the electronic device. When the first identification information, the second identification information, and the third identification information are received, a second electronic key which is different from a first electronic key corresponding to the first identification information and which is to unlock the key is generated and transmitted to one of the first terminal device and the second terminal device.

### BACKGROUND OF THE INVENTION

### Field of the Invention

The present invention relates to an electronic key management device, an electronic key management system, an electronic key management method, and a management method of an electronic key management system.

### Description of Related Art

An electronic lock system that locks or unlocks a door using a terminal device as an electronic key is known (for example, Patent Document 1). Such an electronic lock system does not need exchange of a physical key and thus is often used in lodging facilities, rental studios, rental conference rooms, or the like.

### Patent Documents

[Patent Document 1] Japanese Unexamined Patent Application, First Publication No. 2017-091116

### SUMMARY OF THE INVENTION

In a lodging facility, it is intended to share an electronic key of a door with another person due to a visitor or a temporary stay of a family member. At this time, when the electronic key is easily delivered from a user who is using the facility to a user who wants to share the facility, there is a likelihood that security will not be kept.

In consideration of the aforementioned circumstances, an objective of the present invention is to provide an electronic key management device, an electronic key management system, an electronic key management method, and a management method of an electronic key management system that can easily share an electronic key and keep security.

An electronic key management device according to an aspect of the present invention is an electronic key management device in an electronic key management system including an electronic device and the electronic key management device communicatively connected to the electronic device and managing an electronic key to unlock a key installed in a facility, the electronic key management device including: a first transmitter configured to transmit a first electronic key to unlock the key to a first terminal device in response to a request for use of the facility; a first storage configured to store the first electronic key and first identification information of the first terminal device; a key generator configured to generate a second electronic key which is different from the first electronic key corresponding to the first identification information and which is to unlock the key when the electronic device fixedly provided in the facility acquires first identification information individually allocated to the first terminal device and second identification information individually allocated to a second terminal device other than the first terminal device from the first terminal device used by a user arriving at the facility, the first identification information, the second identification information, and third identification information individually allocated to the electronic device are transmitted from the electronic device, and the first identification information, the second identification information, and the third identification information are received; a second storage configured to store the generated second electronic key and the second identification information; and a third transmitter configured to transmit the second electronic key to one of the first terminal device and the second terminal device.

An electronic key management system according to another aspect of the present invention is an electronic key management system including an electronic device and an electronic key management device communicatively connected to the electronic device and managing an electronic key to unlock a key installed in a facility, wherein the electronic device is an electronic device that is fixedly provided in the facility, wherein the electronic device includes a first acquisitor configured to acquire first identification information individually allocated to a first terminal device and second identification information individually allocated to a second terminal device other than the first terminal device from the first terminal device used by a user arriving at the facility, and a second transmitter configured to transmit the first identification information, the second identification information, and third identification information individually allocated to the electronic device to the electronic key management device, and wherein the electronic key management device includes a first transmitter configured to transmit a first electronic key to unlock the key to the first terminal device in response to a request for use of the facility, a first storage configured to store the first electronic key and the first identification information of the first terminal device, a key generator configured to generate a second electronic key which is different from the first electronic key corresponding to the first identification information and which is to unlock the key when the first identification information, the second identification information, and the third identification information transmitted from the electronic device are received, a second storage configured to store the generated second electronic key and the second identification information, and a third transmitter configured to transmit the second electronic key to one of the first terminal device and the second terminal device.

An electronic key management method according to another aspect of the present invention is an electronic key management method in an electronic key management system including an electronic device and an electronic key management device communicatively connected to the electronic device and managing an electronic key to unlock a key installed in a facility, the electronic key management method including: a step of transmitting a first electronic key to unlock the key to a first terminal device in response to a request for use of the facility; a step of storing the first electronic key and first identification information of the first terminal device; a step of generating a second electronic key which is different from the first electronic key corresponding to the first identification information and which is to unlock the key when the electronic device fixedly provided in the facility acquires first identification information individually allocated to the first terminal device and second identification information individually allocated to a second terminal device other than the first terminal device from the first terminal device used by a user arriving at the facility, the first identification information, the second identification information, and third identification information individually allocated to the electronic device are transmitted from the electronic device, and the first identification information, the second identification information, and the third identification information are received; a step of storing the generated second electronic key and the second identification information; and a step of transmitting the second electronic key to one of the first terminal device and the second terminal device.

A management method of an electronic key management system according to another aspect of the present invention is a management method of an electronic key management system including an electronic device and an electronic key management device communicatively connected to the electronic device and managing an electronic key to unlock a key installed in a facility, wherein the electronic device is an electronic device that is fixedly provided in the facility, the management method including: a step of causing the electronic device to acquire first identification information individually allocated to a first terminal device and second identification information individually allocated to a second terminal device other than the first terminal device from the first terminal device used by a user arriving at the facility; a step of causing the electronic device to transmit the first identification information, the second identification information, and third identification information individually allocated to the electronic device to the electronic key management device; a step of causing the electronic key management device to transmit a first electronic key to unlock the key to the first terminal device in response to a request for use of the facility; a step of causing the electronic key management device to store the first electronic key and the first identification information of the first terminal device; a step of causing the electronic key management device to generate a second electronic key which is different from the first electronic key corresponding to the first identification information and which is to unlock the key when the first identification information, the second identification information, and the third identification information transmitted from the electronic device are received; a step of causing the electronic key management device to store the generated second electronic key and the second identification information; and a step of causing the electronic key management device to transmit the second electronic key to one of the first terminal device and the second terminal device.

According to the present invention, it is possible to keep security and to easily temporarily share an electronic key of a door with another person when there is a visitor, a family member temporarily stays, or the like.

### BRIEF DESCRIPTION OF THE DRAWINGS

FIG. 1 is a diagram schematically illustrating an electronic key management system according to a first embodiment of the present invention.

FIG. 2 is a block diagram schematically illustrating a terminal device in the electronic key management system according to the first embodiment of the present invention.

FIG. 3 is a block diagram schematically illustrating a fixed electronic device in the electronic key management system according to the first embodiment of the present invention.

FIG. 4 is a block diagram schematically illustrating a key management server in the electronic key management system according to the first embodiment of the present invention.

FIG. 5 is a diagram illustrating a process when a temporarily valid electronic key is provided to a sharing user who wants to share a facility.

FIG. 6 is a diagram illustrating a process when a temporarily valid electronic key is provided to a sharing user who wants to share a facility.

FIG. 7 is a block diagram illustrating an electronic key management device according to another aspect of the present invention.

### DETAILED DESCRIPTION OF THE INVENTION

Hereinafter, embodiments of the present invention will be described with reference to the accompanying drawings.

### First embodiment

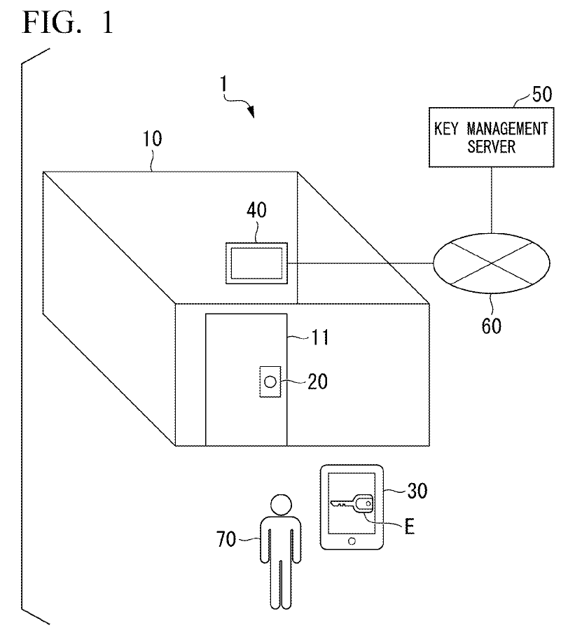

FIG. 1 is a diagram schematically illustrating an electronic key management system 1 according to a first embodiment of the present invention. In FIG. 1, a facility 10 is a facility which can be used by a general user through reservation or notification such as a lodging facility, a rental store, a rental studio, or a rental conference room. An electronic lock 20 is attached to a door 11 of the facility 10. An electronic key E for locking or unlocking the electronic lock 20 is stored in a terminal device 30. An application program for locking and unlocking the electronic lock 20 using the electronic key E is installed in the terminal device 30. The electronic lock 20 of the door 11 and the terminal device 30 can communicate according to one of Bluetooth low energy (BLE) (Bluetooth is registered trademark) and near field communication (NFC).

A user 70 who uses the facility 10 acquires the electronic key E for unlocking and locking the electronic lock 20 in advance and stores the electronic key E in the terminal device 30 when reservation or notification is performed. Then, the user 70 locks and unlocks the door 11 by causing the electronic lock 20 to read the electronic key E of the terminal device 30.

A fixed electronic device 40 is provided in the facility 10. A personal computer (PC), a tablet terminal, a terminal device, or the like is used as the fixed electronic device 40. A display device that displays guidance of the facility 10 may be used as the fixed electronic device 40. The fixed electronic device 40 is fixed and installed to a structure such as a wall or furniture such that the fixed electronic device 40 cannot move from the inside of the facility 10. When a mobile terminal such as a table terminal or a terminal device is used as the fixed electronic device 40, the fixed electronic device 40 is attached to a fixed object via a wire or the like and is installed not to move from the inside of the facility 10. The fixed electronic device 40 may be fastened to a structure of the facility 10 by a screw or may be connected to a structure using a chain, an adhesive, a cohesive agent, or the like.
The fixed electronic device 40 is connected to a key management server 50 via a network 60. The fixed electronic device 40 is used to issue a temporarily valid electronic key to a user who wants to share the facility 10.

The key management server 50 is constituted by one or more server devices (for example, cloud server). The key management server 50 issues an electronic key to a user who uses the facility 10 when the user performs reservation or notification. The key management server 50 issues a temporarily valid electronic key to a user who wants to share the facility 10.

In the following description, a user who performs reservation or notification and uses the facility 10 is referred to as a regular user, and an electronic key (a first electronic key) issue to the regular user is referred to as a regular electronic key. A user who shares the facility 10 with the regular user is referred to as a sharing user, and a temporarily valid electronic key (a second electronic key) issued to the sharing user is referred to as a temporarily valid electronic key. The regular electronic key and the sharing electronic key can be set to different use conditions. For example, the temporarily valid electronic key is a key which is temporarily used by a sharing user, and a period of validity is limited to a period shorter than that of the regular electronic key. It is conceivable that the period of validity of the temporarily valid electronic key is set to a predetermined time (for example, one day) and a process of re-issuing a temporarily valid electronic key is performed when the period of validity is extended.

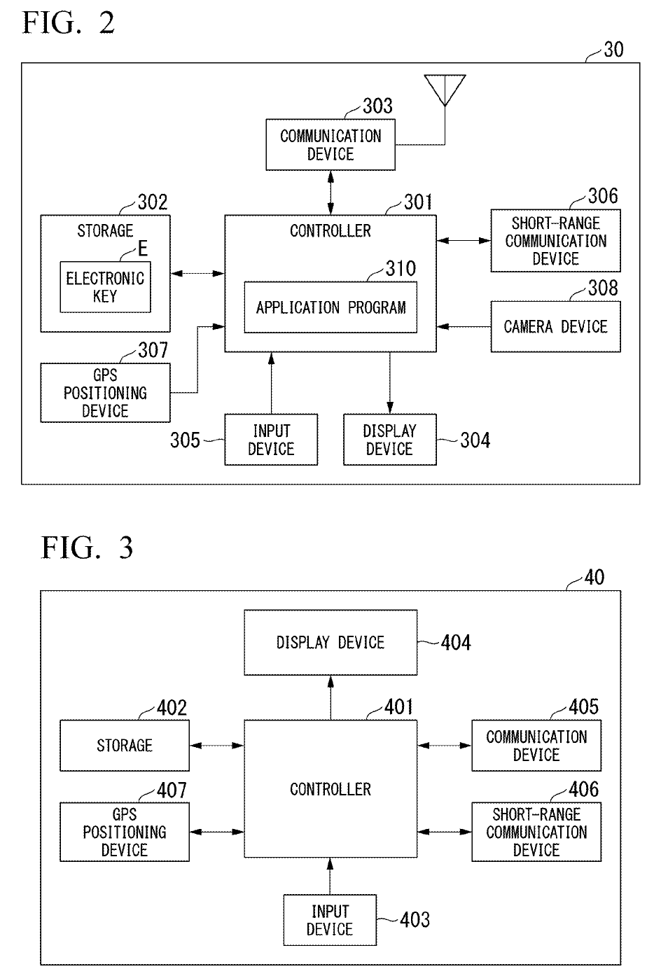

FIG. 2 is a block diagram schematically illustrating the terminal device 30 in the electronic key management system 1 according to the first embodiment of the present invention.

As illustrated in FIG. 2, the terminal device 30 includes a controller 301, a storage 302, a communication device 303, a display device 304, an input device 305, a short-range communication device 306, a global positioning system (GPS) positioning device 307, and a camera device 308.

The controller 301 is constituted by a central processing unit (CPU) and performs various processes on the basis of programs stored in the storage 302. In the present embodiment, the controller 301 performs processes of the application program 310 for locking and unlocking the electronic lock 20.

The storage 302 is constituted by, for example, a hard disk drive (HDD), a flash memory, an electrically erasable programmable read only memory (EEPROM), a random access read/write memory (RAM), a read only memory (ROM), or an arbitrary combination of these storage media. The electronic key E is stored in the storage 302.

The communication device 303 performs mobile communication. As a communication system, various systems such as 2G (frequency division multiple access (FDMA) or time division multiple access (TDMA)), 3G (wideband code division multiple access (W-CDMA)), 4G (long term evolution (LTE)), and 5G have been proposed, and any system may be used. A wireless LAN (IEEE 802.11) may be used for the communication device 303.

The display device 304 is constituted by, for example, a liquid crystal display (LCD) or an organic electroluminescence (EL) display. Various types of information are displayed on the display device 304.

The input device 305 is constituted, for example, a touch panel stacked on the display device 304 and receives various operation inputs from a user.

The short-range communication device 306 is used for communication with the electronic lock 20 or the fixed electronic device 40. BLE or NFC may be used for the short-range communication device 306.

The GPS positioning device 307 measures a position of the terminal device 30.
The camera device 308 images the surroundings. The camera device 308 images a two-dimensional barcode and extracts information included in the two-dimensional barcode by analyzing the imaged two-dimensional barcode.

FIG. 3 is a block diagram schematically illustrating the fixed electronic device 40 in the electronic key management system 1 according to the first embodiment of the present invention.

As illustrated in FIG. 3, the fixed electronic device 40 includes a controller 401, a storage 402, an input device 403, a display device 404, a communication device 405, a short-range communication device 406, and a GPS positioning device 407.

The function of the controller 401 may be realized by causing a CPU mounted in the fixed electronic device 40 to read and execute a program stored in the storage 402. The controller 401 performs various processes. In the present embodiment, when a temporarily valid electronic key is issued to a sharing user 70b who wants to share the facility 10, the controller 401 performs a process of acquiring identification information (first identification information) of a terminal device 30a carried by a regular user, identification information (second identification information) of a terminal device 30b carried by the sharing user, and identification information and position information (third identification information) of the fixed electronic device 40 and transmitting the acquired information to the key management server 50. Here, a media access control address (a MAC address) can be used as identification information. The identification information is not limited to a MAC address, and any may be used as long as it is information for identifying a device. The controller 401 performs a process of acquiring necessary parameters for generating a temporarily valid electronic key for the sharing user and transmitting the acquired parameters to the key management server 50.

At least one of the following data (a) to (e) can be used as the necessary parameters for generating a temporarily valid electronic key.
a) Identification information and position information of the fixed electronic device 40
(b) A regular electronic key held by a regular user
(c) A period of validity of a regular electronic key
(d) Check-in time (random information)
(e) Identification information of a terminal device of a sharing user

A parameter for generating an electronic key may be acquired by the fixed electronic device 40 by causing the terminal device 30 of a regular user and the fixed electronic device 40 to communicate when the regular user enters the facility 10 and performs check-in. Information of the check-in time is random information. The position information of the fixed electronic device 40 can be acquired by the GPS positioning device 407.

The storage 402 is constituted by, for example, an HDD, a flash memory, an EEPROM, a RAM, a ROM, or an arbitrary combination of these storage media. Various programs or data are recorded and/or reproduced in the storage 402.

The input device 403 is a touch panel stacked on the display device 404 and receives various inputs from a user. The input device 403 may be an input device such as a keyboard or a mouse.

The display device 404 is constituted by, for example, an LCD display or an organic EL display. Various types of information are displayed on the display device 404. The display device 404 can be used to display various types of information in a two-dimensional barcode.

The communication device 405 performs communication with the key management server 50 via the network 60. The communication device 405 serves as a transmitter (a second transmitter) that transmits the identification information (the first identification information) of the terminal device 30 carried by the regular user, the identification information (the second identification information) of the terminal device 30 carried by the sharing user, and the identification information and the position information (the third identification information) of the fixed electronic device 40 to the key management server 50.

The short-range communication device 406 is used for communication with the terminal device 30. BLE or NFC Is used for the short-range communication device 406. Various types of necessary information or necessary parameters for generating a temporarily valid electronic key can be acquired by causing the short-range communication device 406 to communicate with the terminal device 30. Communication with the terminal device 30 may be performed using the function of a wireless LAN of the communication device 405.

The GPS positioning device 407 measures an installation position of the fixed electronic device 40. Since the fixed electronic device 40 is used in a fixed state, the fixed electronic device 40 can be identified from position information acquired by the GPS positioning device 407. It is possible to detect whether the fixed electronic device 40 has moved by using the position information acquired by the GPS positioning device 407.

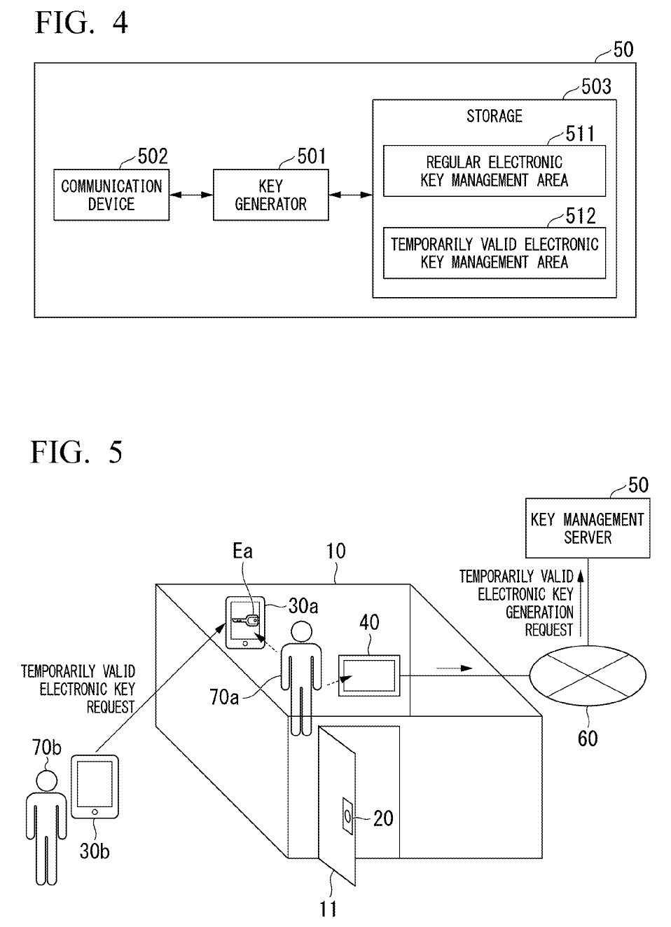

FIG. 4 is a block diagram schematically illustrating the key management server 50 in the electronic key management system 1 according to the first embodiment of the present invention. As illustrated in FIG. 4, the key management server 50 includes a key generator 501, a communication device 502, and a storage 503.

The key generator 501 generates an electronic key for locking and unlocking the door 11. A regular electronic key (a first electronic key) used by a regular user is generated by the key generator 501 when the regular user performs reservation or notification to use the facility 10.

The communication device 502 transmits the regular electronic key generated by the key generator 501 to the terminal device of the regular user (a first transmitter).

The communication device 502 receives a temporarily valid electronic key generation request from the fixed electronic device 40.

The key generator 501 receives the temporarily valid electronic key generation request and generates a temporarily valid electronic key. At this time, the communication device 502 receives the identification information of the terminal device 30 carried by the regular user, the identification information of the terminal device 30 carried by the sharing user, and the identification information and the position information of the fixed electronic device 40 as necessary information from the fixed electronic device 40. The communication device 502 receives a parameter for generating a temporarily valid electronic key from the fixed electronic device 40 at the time of issuing of the temporarily valid electronic key.

The key generator 501 generates a temporarily valid electronic key (a second electronic key) using the received parameter. Then, the communication device 502 transmits the generated temporarily valid electronic key to the fixed electronic device 40 (a third transmitter).

The storage 503 is constituted by, for example, an HDD, a flash memory, an EEPROM, a RAM, a ROM, or an arbitrary combination of these storage media.

A regular electronic key management area 511 (a first storage) and a temporarily valid electronic key management area 512 (a second storage) are provided in the storage 503.

In the regular electronic key management area 511, the regular electronic key issued to the regular user and the identification information of the terminal device 30 which can use the electronic key are stored in correlation. In the temporarily valid electronic key management area 512, the temporarily valid electronic key issued to the sharing user and the identification information of the terminal device 30 which can use the electronic key are stored in correlation.

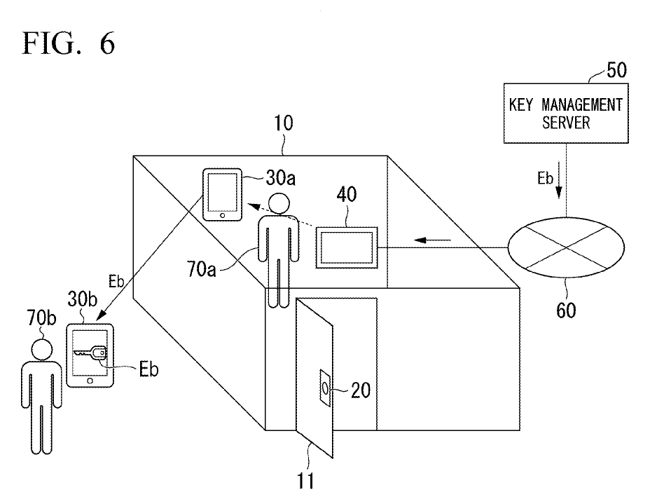

FIGS. 5 and 6 are diagrams illustrating a process when a temporarily valid electronic key is provided to a sharing user who wants to share the facility 10 in the electronic key management system 1 according to the first embodiment of the present invention.

In FIGS. 5 and 6, a regular user 70a carries a terminal device 30a. A sharing user 70bcarries a terminal device 30b. Electronic keys include a regular electronic key Ea (a first electronic key) and a temporarily valid electronic key Eb (a second electronic key). The regular electronic key Ea is an electronic key used by the regular user 70a. The temporarily valid electronic key Eb is an electronic key used by the sharing user 70b.

The regular user 70a holds the regular electronic key Ea that can unlock and lock the door 11 of the facility 10 in the terminal device 30a at the time of reservation. As illustrated in FIG. 5, when the user 70a arrives at the facility 10, the user 70a unlocks the door 11 using the regular electronic key Ea of the terminal device 30a and enters the facility 10.

Here, it is assumed that the sharing user 70b wants to share the facility 10. In this case, the sharing user 70b who wants to share the facility 10 transmits a request for a temporarily valid electronic key to the terminal device 30a of the regular user 70a using the terminal device 30b of the sharing user 70b. The regular user 70a receives the request for a temporarily valid electronic key from the sharing user 70b using the terminal device 30a.

The regular user 70a having received the request for a temporarily valid electronic key operates the terminal device 30a and the fixed electronic device 40 in the facility 10 and transmits the request for a temporarily valid electronic key to the key management server 50. At this time, the fixed electronic device 40 acquires the identification information of the terminal device 30a of the regular user 70a and the identification information of the terminal device 30b of the sharing user 70b from the terminal device 30a and transmits the identification information of the terminal device 30a of the regular user 70a, the identification information of the terminal device 30b of the sharing user 70b, and the identification information and the position information of the fixed electronic device 40 as necessary information to the key management server 50. The fixed electronic device 40 acquires the identification information and the position information of the fixed electronic device 40, the regular electronic key Ea held by the regular user 70a, the period of validity of the regular electronic key Ea, the check-in time, the identification information of the terminal device 30b of the sharing user 70b, and the like as necessary parameters for generating a key and transmits the acquired information to the key management server 50.

When the necessary parameter and the necessary information for generating a key along with the request for a temporarily valid electronic key are received from the fixed electronic device 40, the key management server 50 generates a temporarily valid electronic key Eb.

As illustrated in FIG. 6, the generated temporarily valid electronic key Eb is sent from the key management server 50 to the terminal device 30b of the sharing user 70b, but may be sent to the terminal device 30b via the fixed electronic device 40 or may be sent to the terminal device 30b via the terminal device 30a. That is, in the example illustrated in FIG. 6, the generated temporarily valid electronic key Eb is sent from the key management server 50 to the fixed electronic device 40. The fixed electronic device 40 receives the temporarily valid electronic key Eb sent from the key management server 50 and transmits the received temporarily valid electronic key Eb to the terminal device 30a of the regular user 70a. Then, the regular user 70a transmits the temporarily valid electronic key Eb from the terminal device 30a to the terminal device 30b of the sharing user 70b. The sharing user 70b stores the temporarily valid electronic key Eb sent from the regular user 70a in the terminal device 30b. Accordingly, the sharing user 70b can lock and unlock the door 11 of the facility 10 using the temporarily valid electronic key Eb stored in the terminal device 30b.

As described above, in the present embodiment, a user needs to use the fixed electronic device 40 to generate a temporarily valid electronic key. The fixed electronic device 40 is fixed in the facility 10. Accordingly, the user needs to enter the facility 10 to use the fixed electronic device 40. The regular user 70a holding the regular electronic key Ea that can unlock the door 11 of the facility 10 can enter the facility 10. As a result, in the present embodiment, a user who can share the facility 10 as the sharing user 70b can be limited to a user associated with the regular user 70a.

In the present embodiment, the identification information of the terminal device 30a carried by the regular user 70a, the identification information of the terminal device 30b carried by the sharing user 70b, and the identification information and the position information of the fixed electronic device 40 are transmitted as necessary information from the fixed electronic device 40 to the key management server 50. It is possible to acquire information of a terminal having requested to generate the temporarily valid electronic key using such information. Accordingly, it is possible to curb issuing of a key based on impersonation and to achieve keeping of security.

The fixed electronic device 40 is assembled into a wall, furniture, or the like and is installed not to move from the inside of the facility 10. Accordingly, there is no likelihood that the fixed electronic device 40 will be taken out and used to generate a temporarily valid electronic key. The GPS positioning device 407 is provided in the fixed electronic device 40, and the position information thereof is transmitted from the fixed electronic device 40 to the key management server 50 at the time of generation of a temporarily valid electronic key. Accordingly, it is possible to detect movement of the fixed electronic device 40. As a result, it is possible to prohibit the fixed electronic device 40 from being taken out and used to generate a temporarily valid electronic key.

As described above, in the present embodiment, the parameter for generating a temporarily valid electronic key includes the identification information of the terminal device 30b of the sharing user 70b. Accordingly, the temporarily valid electronic key Eb used by the sharing user 70b can be set to be valid only in the terminal device 30b of the sharing user 70b.

That is, when a request for unlocking is received from the terminal device 30b of the sharing user 70b, the electronic lock 20 receives the identification information of the terminal device 30b and the temporarily valid electronic key Eb from the terminal device 30b and sends a combination of the received identification information of the terminal device 30b and the received temporarily valid electronic key Eb to the key management server 50. The identification information of the terminal device 30b and the temporarily valid electronic key Eb are stored in correlation in the storage 503 of the key management server 50. When the identification information of the terminal device 30b and the temporarily valid electronic key Eb are received from the terminal device 30b, the key management server 50 determines whether the received combination of the identification information of the terminal device 30b and the temporarily valid electronic key Eb matches the combination of the identification information of the terminal device 30b and the temporarily valid electronic key Eb stored in the storage 503 of the key management server 50. Then, the electronic lock 20 permits unlocking when the received combination of the identification information of the terminal device 30b and the temporarily valid electronic key Eb matches the combination of the identification information of the terminal device 30b and the temporarily valid electronic key Eb stored in the storage 503 of the key management server 50.

### Modifications, Applications

In the aforementioned first embodiment, when the temporarily valid electronic key Eb generated by the key management server 50 is sent to the terminal device 30b of the sharing user 70b, the key management server 50 transmits the temporarily valid electronic key Eb to the fixed electronic device 40, and information of the temporarily valid electronic key Eb is transmitted from the fixed electronic device 40 to the terminal device 30a of the regular user 70a and is transmitted from the terminal device 30a of the regular user 70a to the terminal device 30b of the sharing user 70b.

A reading code may be used to transmit the temporarily valid electronic key Eb from the fixed electronic device 40 to the terminal device 30a. That is, the key management server 50 transmits a reading code (a two-dimensional barcode) indicating the temporarily valid electronic key Eb to the fixed electronic device 40 (a fourth transmitter). When information is received from the key management server 50, the fixed electronic device 40 displays the two-dimensional barcode indicating the temporarily valid electronic key Eb on the display device 404. The regular user 70a reads the displayed two-dimensional barcode using the camera device 308 of the terminal device 30a. Accordingly, the temporarily valid electronic key Eb can be transmitted from the fixed electronic device 40 to the terminal device 30a.

The two-dimensional barcode displayed on the fixed electronic device 40 needs not to be displayed in order to keep security after it has been read by the terminal device 30a. Accordingly, the two-dimensional barcode displayed on the fixed electronic device 40 is not displayed after a predetermined time has elapsed. The terminal device 30a may transmit an end notification to the key management server 50 when the two-dimensional barcode is read, and the key management server 50 may cause the two-dimensional barcode not to be displayed when the end notification is received.

The key management server 50 may transmit information (URL: uniform resource locator) for downloading the temporarily valid electronic key Eb instead of information of the temporarily valid electronic key Eb itself to the terminal device 30b of the sharing user 70b. When information of the URL in which the temporarily valid electronic key Eb is stored is received, the sharing user 70b accesses the URL using the terminal device 30b. Accordingly, it is possible to acquire the temporarily valid electronic key Eb.

The temporarily valid electronic key Eb generated by the key management server 50 may be sent from the key management server 50 to the terminal device 30a of the regular user 70a and transmitted to the terminal device 30b of the sharing user 70b therefrom. When the temporarily valid electronic key Eb is sent from the key management server 50 to the terminal device 30a, information of the temporarily valid electronic key Eb may not be directly sent, but information of the URL for downloading the temporarily valid electronic key Eb may be sent.

In the aforementioned first embodiment, the temporarily valid electronic key Eb generated by the key management server 50 is transmitted from the key management server 50 to the terminal device 30b of the sharing user 70b via the fixed electronic device 40 and the terminal device 30a. This is because the sharing user 70b is not the user having performed reservation or notification for use of the facility 10 and thus a destination or a mail address of the terminal device 30b of the sharing user 70b is not apparent to the key management server 50.

When a mail address of a destination of the terminal device 30b of the sharing user 70b is registered in the key management server 50, the temporarily valid electronic key Eb generated by the key management server 50 can be directly sent from the key management server 50 to the terminal device 30b. When the temporarily valid electronic key Eb is sent from the key management server 50 to the terminal device 30b, information of the temporarily valid electronic key Eb may not be directly sent, but information of the URL for downloading the temporarily valid electronic key Eb may be sent.

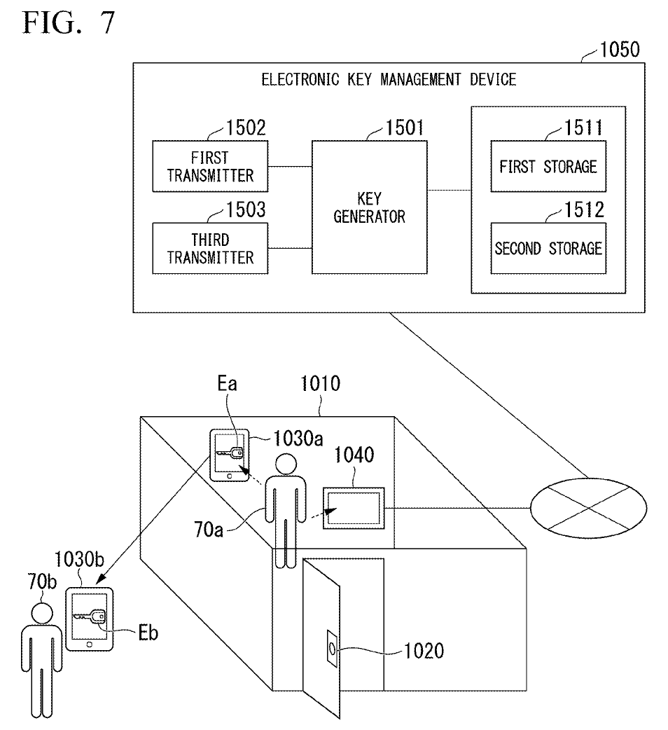

FIG. 7 is a block diagram in another aspect of the electronic key management device according to the present invention. An electronic key management device 1050 is used in an electronic key management system including an electronic device 1040 and the electronic key management device 1050 communicatively connected to the electronic device 1040 and managing an electronic key that can unlock a lock 1020 provided in a facility 1010.

The electronic key management device 1050 includes a first transmitter 1502, a first storage 1511, a key generator 1501, and a second storage 1512.

The first transmitter 1502 transmits a first electronic key Ea that can unlock the lock 1020 to a first terminal device 1030a in response to a request for use of the facility 1010.

The first storage 1511 stores the first electronic key Ea and first identification information of the first terminal device 1030a.

When the electronic device 1040 fixedly provided in the facility 1010 acquires first identification information individually allocated to the first terminal device 1030a and second identification information individually allocated to a second terminal device 1030b other than the first terminal device 1030a from the first terminal device 1030a used by a user 70a arriving at the facility 1010, the first identification information, the second identification information, and third identification information individually allocated to the electronic device 1040 are transmitted from the electronic device 1040, and the first identification information, the second identification information, and the third identification information are received, the key generator 1501 generates a second electronic key Eb which is different from the first electronic key Ea corresponding to the first identification information and which is to unlock the key 1020.

The second storage 1512 stores the generated second electronic key Eb and the second identification information.

The third transmitter 1503 transmits the second electronic key Eb to one of the electronic device 1040, the first terminal device 1030a, and the second terminal device 1030b. The third transmitter 1503 may transmit the second electronic key Eb to one of the first terminal device 1030a and the second terminal device 1030b via the electronic device 1040.

The whole or a part of the electronic key management system 1 according to the aforementioned embodiments may be realized by a computer. In this case, the whole or a part thereof may be realized by recording a program for realizing the functions on a computer-readable recording medium and causing a computer system to read and execute the program recorded on the recording medium. The “computer system” mentioned herein includes an OS or hardware such as peripherals. The “computer-readable recording medium” is a portable medium such as a flexible disk, a magneto-optical disc, a ROM, or a CD-ROM or a storage device such as a hard disk incorporated into a computer system. The “computer-readable recording medium” may include a medium that dynamically holds a program for a short time such as a communication line when a program is transmitted via a network such as the Internet or a communication circuit line such as a telephone line or a medium that holds a program for a predetermined time such as a volatile memory in a computer system serving as a server or a client in that case. The program may be a program for realizing some of the aforementioned functions, may be a program for realizing the aforementioned functions in combination with another program stored in advance in the computer system, or may be a program for realizing the aforementioned functions using a programmable logic device such as an FPGA.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

10 Facility
11 Door
20 Electronic lock
30, 30a, 30b Terminal device
40 Fixed electronic device
50 Key management server
501 Key generator
502 Communication device
503 Storage
511 Regular electronic key management area
512 Temporarily valid electronic key management area

What is claimed is:

1. An electronic key management device in an electronic key management system, the electronic key management system including an electronic device and the electronic key management device, the electronic key management device being communicatively connectable to the electronic device, the electronic key management system being configured to manage an electronic key to unlock a key installed in a facility, the electronic key management device comprising:
a first transmitter configured to transmit a first electronic key to unlock the key to a first terminal device in response to a request for use of the facility;
a first storage configured to store the first electronic key and a first identification information of the first terminal device;
a key generator configured to generate a second electronic key to unlock the key, upon receipts of the first identification information, a second identification information, and a third identification information transmitted from the electronic device, wherein the second electronic key is different from the first electronic key that corresponds to the first identification information, the electronic device is fixedly provided in the facility, the electronic device has acquired the first identification information, the second identification information, and the third identification information, the first identification information has been individually allocated to the first terminal device by the first terminal device which has been in use by a user having arrived at the facility, the second identification information has been individually allocated to a second terminal device other than the first terminal device, the third identification information has been individually allocated to the electronic device which has been in use by the user;
a second storage configured to store the second electronic key generated and the second identification information; and
a third transmitter configured to transmit the second electronic key to anyone of the first terminal device and the second terminal device.

2. The electronic key management device according to claim 1, wherein the third transmitter is configured to transmit the second electronic key to the first terminal device, to allow the second electronic key to be transmitted from the first terminal device to the second terminal device.

3. The electronic key management device according to claim 1, wherein the third transmitter is configured to transmit, to the first terminal device, a URL at which the second electronic key is downloadable, to allow the URL to be transmittable from the first terminal device to the second terminal device, and to allow the second terminal device to download the second electronic key to the second terminal device on the basis of the URL.

4. The electronic key management device according to claim 1, wherein the electronic device is fixedly attached to a structure of the facility.

5. The electronic key management device according to claim 1, wherein the key generator is configured to allocate, to the second electric key, a period of validity which is shorter than a period of use booked for the user to use the facility.

6. The electronic key management device according to claim 1, further comprising:
an unlocking controller configured to determine whether a combination of the identification information and the electronic key has been stored in the second storage, upon receipts of a request for unlocking the key from a terminal device, of the identification information individually allocated to the terminal device, and of the electronic key, and
the unlocking controller being configured to allow for unlocking the key in case that the unlocking controller determined that the combination of the identification information and the electronic key is stored in the second storage.

7. The electronic key management device according to claim 1, further comprising:
a fourth transmitter configured to transmit, to the electronic device, a reading code for acquiring the second electronic key generated,
wherein the electronic device displays, on a display screen, the reading code transmitted from the electronic key management device and the electronic device hides the reading code in response to that the reading code has been read by the first terminal device.

8. The electronic key management device according to claim 1, wherein the third transmitter is configured to transmit the second electronic key to anyone of the first terminal device and the second terminal device via the electronic device.

9. An electronic key management system for managing an electronic key to unlock a key installed in a facility, the electronic key management system comprising:
an electronic device; and
an electronic key management device communicatively connected to the electronic device,
wherein the electronic device is fixedly provided in the facility,
wherein the electronic device comprises:
a first acquisitor configured to acquire, from the first terminal device used by a user having arrived at the facility, a first identification information individually allocated to a first terminal device and a second identification information individually allocated to a second terminal device other than the first terminal device, and
a first transmitter configured to transmit, to the electronic key management device, the first identification information, the second identification information, and a third identification information individually allocated to the electronic device, and
wherein the electronic key management device comprises:
a second transmitter configured to transmit, to the first terminal device, a first electronic key to unlock the key in response to a request for use of the facility,
a first storage configured to store the first electronic key and the first identification information of the first terminal device,
a key generator configured to generate a second electronic key to unlock the key, upon receipts of the first identification information, the second identification information, and the third identification information transmitted from the electronic device, wherein the second electronic key is different from the first electronic key that corresponds to the first identification information,
a second storage configured to store the generated second electronic key and the second identification information, and
a third transmitter configured to transmit the second electronic key to anyone of the first terminal device and the second terminal device.

10. An electronic key management method in an electronic key management system for managing an electronic key to unlock a key installed in a facility, the electronic key management system comprising an electronic device and an electronic key management device communicatively connected to the electronic device, the electronic key management method comprising:
transmitting, by the electronic key management device, a first electronic key to unlock the key to a first terminal device in response to a request for use of the facility;
storing, by the electronic key management device, the first electronic key and a first identification information of the first terminal device;
generating, by the electronic key management device, a second electronic key to unlock the key, upon receipts of the first identification information, a second identification information, and a third identification information transmitted from the electronic device, wherein the second electronic key is different from the first electronic key that corresponds to the first identification information, the electronic device is fixedly provided in the facility, the electronic device has acquired the first identification information, the second identification information, and the third identification information, the first identification information has been individually allocated to the first terminal device by the first terminal device which has been in use by a user having arrived at the facility, the second identification information has been individually allocated to a second terminal device other than the first terminal device, the third identification information has been individually allocated to the electronic device which has been in use by the user;
storing, by the electronic key management device, the second electronic key generated and the second identification information; and
transmitting, by the electronic key management device, the second electronic key to anyone of the first terminal device and the second terminal device.
